(19) United States
(12) Patent Application Publication
(10) Pub. No.: US 2010/0279063 A1
(43) Pub. Date: Nov. 4, 2010

(54) Breaker plates for shaking tables and rotary drums

(76) Inventors: Dale M. Homeniuk, Edmonton (CA); Jay Spate, Edmonton (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(21) Appl. No.: 12/662,721

(22) Filed: Apr. 30, 2010

Related U.S. Application Data
(60) Provisional application No. 61/213,058, filed on May 1, 2009.

(51) Int. Cl. B32B 3/10

(52) U.S. Cl. 428/137; 428/131

(57) ABSTRACT

Carbon steel breaker plates mounted internally in rotary drums or on planar shaking tables and having holes for the sizing and passage of undersized material are provided with an array of protruding shapes which may be pyramid-shaped or wedge-shaped or otherwise shaped for breaking down large cohesive lumps or agglomerates passing over the breaker plates. The protrusions have abrasion, wear and impact resistant coatings for use in high wear applications.

### BACKGROUND OF THE INVENTION

(i) Field of the Invention

This invention relates to apparatus for processing large cohesive lumps or agglomerates of abrasive materials for size reduction and, more particularly, relates to breaker plates having protrusions with an abrasion, wear and impact resistant coating for size reduction and sieving in high wear applications typified by the mining of oil sands or coal.

Mining of oil sands involves excavation and transfer of huge volumes of stratified sand saturated with bitumen for recovery of hydrocarbons. The sand essentially is a quartz sand angular in shape and as a result very abrasive to steel equipment. The hard facing of steel equipment to resist wear and erosion by coating exposed steel surfaces with tungsten carbide particles dispersed in a matrix of mild steel or a nickel- or cobalt-base alloy is known. U.S. Pat. No. 4,013,453 for example discloses hard surfacing of a metal substrate by coating with a nickel-base matrix powder mixed with coarse tungsten carbide particles to resist wear and abrasion. It is stated that such coatings are sensitive to thermal cracking and spalling due to the brittle nature of the coating.

The hard facing of equipment used for the mining and handling of oil sands is particularly sensitive to wear, to erosion clue to abrasion, and to spalling due to the shock of impact from dropping of large lumps of oil sand on shaker boxes or rotary breaker drums for wet screening the sands with water and for breaking oversized cohesive lumps down to a size suitable for passage as undersize through hole openings in the shaker boxes and rotary drums. U.S. patent application Ser. No. 12/153,327, the contents of which are incorporated herein by reference, discloses hard lacing a metal substrate with a two-layer abrasion and impact resistant coating by fusing a softer inner first coat of a matrix alloy of nickel-, cobalt- or iron-base alloy with carbide particles onto the substrate and fusing a harder second outer coat of a matrix alloy of nickel-, cobalt- or iron-base alloy with angular carbide particles onto the softer inner first coat. The softer inner first coat preferably has a hardness of about 30-40 Rc and the harder outer second coat preferably has a hardness of about 50-60 Rc. The carbide particles preferably are tungsten carbide particles in the size range of about 60 to 250μ and comprise about 55 to 65 wt % of each of the inner and outer coats.

The large cohesive oversized lumps of oil sands feed material which are not broken down during the primary breaking and size reduction process tend to flow through or across the sieve structure of the sizing equipment necessitating recycling of the material or loss of valuable product, or causing excessive wear and impact damage to the breaker plates.

### SUMMARY OF THE INVENTION

It is a principal object of the present invention therefore to provide breaker plates for improved size reduction of oversized lumps of cohesive material typified by oil sands as the over size lumps are received from primary crushing.

In its broad aspect, the breaker plate of the invention comprises a rectangular plate with spaced-apart sidewalls and endwalls and equispaced rows of holes formed in the plate extending across the plate on a surface thereof from one side to the other, and rows of pyramid projections or wedge projections formed on the surface of the plate between the rows of holes and extending from one side of the plate to the other. One or a plurality of the pyramid projections or wedge projections are formed on base strips and the base strips attached by welding onto the surface of the plate. The pyramid projections or wedge projections may be attached to the surface of the plate out of alignment with the holes or the rows of the pyramid projections may be attached to the surface of the plate with alternate rows out of alignment with the holes. The pyramid projections or wedge projections preferably are hard surfaced with a dual layer hard faced coating for impact resistance.

### BRIEF DESCRIPTION OF THE DRAWINGS

The apparatus of the invention will now be described with reference to the accompanying drawings, in which:

FIG. 1 is perspective view of a prior art breaker plate having transverse wear and breaker ribs;

FIG. 2 is a perspective view of a first embodiment of breaker plate of the present invention for use on shaker tables;

FIG. 3 is a perspective view of a second embodiment of breaker plate of the invention for use in a rotary breaker; and

FIG. 4 is a perspective view of a third embodiment of breaker plate of the invention for use in a rotary breaker.

### DESCRIPTION OF THE PREFERRED EMBODIMENTS

As has been described in U.S. patent application Ser. No. 12/153,327, the hard facing of steel equipment used in the excavation and transfer of oil sands by providing dual layers of a particulate carbide such as tungsten carbide dispersed in a metal alloy matrix on a metal substrate, wherein the matrix metal of an inner first layer metallurgically bonded to the substrate is softer than the matrix metal of an outer second layer metallurgicaly bonded to the inner layer, substantially enhances the wear, abrasion and impact resistance of the hard facing.

The metal matrix alloy may be nickel-, cobalt- or iron-based and may comprise, for example, a nickel-base matrix alloy for the first and second layers, or a nickel-base matrix alloy for the first layer and an iron-base matrix alloy metallurgically-bonded onto the first nickel-base matrix alloy. Dual layers of nickel-base alloys have been found suitable for rolling, high impact rotary breaker screens whereas a second layer of a less expensive iron-base matrix alloy containing dispersed angular tungsten carbide particles metallurgically-bonded onto a nickel-base matrix alloy has been found suitable for sliding, low impact screen applications encountered in high volume applications having smaller impact forces.

The particulate carbide, preferably tungsten carbide, comprises about 55 to 65 wt % of the coatings, the carbides of the first inner layer preferably being rounded, i.e. non-angular, and the carbides of the second outer layer being angular such as produced from crushed and sintered friable tungsten carbide.

The inner layer must be softer than the outer layer and we have found that an inner layer having a matrix hardness of about 30-40 Rc and an outer layer having a matrix hardness of about 50-60 Rc surprisingly provide significantly improved hard facing to steel wear surfaces.

The matrix alloy layers containing dispersed carbides of the inner and outer layers preferably are deposited in a thickness in the range of 2.5-3.5 mm. The orientation of the second layer should be deposited in a different orientation than the orientation of the first layer, preferably perpendicular to the orientation of the first layer or in the range of 45 to 90° to the orientation of the first layer.

The hard facing of a metal substrate, typically a steel substrate, is applied in two passes, preferably by plasma transferred are welding. Each pass should be applied so that the second pass overlaps and is fused to the first pass, and not in the same orientation, preferably at an angle of from about 45 to about 90° to each other. The first pass involves welding a mixture comprised, for example, of about 37 to 43 wt % nickel-based matrix alloy containing about 3.8 wt % C, 1.2 wt % B, 4.0 wt % Si, 6.7 wt % Cr, 2.1 wt % Fe and 82.2 wt % Ni and about 63 to 57 wt % dense and non-angular tungsten carbide particles by plasma transferred are welding at a temperature in the range of about 250-350° C. preferably about 290° C., onto a steel substrate at a thickness in the range of 2.5 to 3.5 mm.

A first inner coat produced by the method of the invention at a temperature of 290° C. with nickel-based particles and tungsten carbide particles having a mesh size of 63 to 180μ had the following representative percent compositions, with indicated hardness.

PTA Alloy #1 Matrix Hardness Rc 33-34

| Carbon | Boron | Silicon | Chrome | Iron | Nickel | Tungsten |
|---|---|---|---|---|---|---|
| 3.75-3.90 | 0.5-0.59 | 1.55-1.67 | 2.8-2.9 | 0.9-0.99 | 33.2-34.9 | Balance |

PTA Alloy #2 Matrix Hardness Rc 31-32

| Carbon | Boron | Silicon | Chrome | Iron | Nickel | Tungsten |
|---|---|---|---|---|---|---|
| 3.84-3.96 | 0.48-0.52 | 1.60-1.64 | 2.65-2.82 | 0.85-0.94 | 34.1-35.1 | Balance |

PTC Alloy #3 Matrix Hardness Rc 35-36

| Carbon | Boron | Silicon | Chrome | Iron | Nickel | Tungsten |
|---|---|---|---|---|---|---|
| 3.82-3.93 | 0.52-0.56 | 1.59-1.67 | 2.75-2.89 | 0.92-1.01 | 33.9-34.8 | Balance |

The second pass onto the coat of the first pass involves welding a mixture comprised, for example, of about 37 to 43 wt % nickel-based alloy particles containing 2.3 wt % C, 3 wt % B, 3 wt % Si, 0.5 wt % Fe and 91.2 wt % Ni and about 63 wt % to 57 wt % dense and angular friable sintered tungsten carbide particles in a cast and crushed condition by plasma transferred are welding at a temperature in the range of about 300 to 375° C. preferably about 315° C. at a thickness in the range of 2.5 to 3.5 mm.

A second outer coat produced by the method of the invention at a temperature of 315° C. With nickel-based particles and tungsten carbide particles having a mesh size of 63 to 150μ had the following representative compositions with indicated hardness.

PTA Alloy #4 Matrix Hardness Rc 52-54

| Carbon | Boron | Silicon | Iron | Nickel | Tungsten |
|---|---|---|---|---|---|
| 2.30-2.40 | 1.22-1.29 | 1.18-1.29 | 0.17-0.24 | 37.05-37.44 | Balance |

PTA Alloy #5 Matrix Hardness Rc 55-58

| Carbon | Boron | Silicon | Iron | Nickel | Tungsten |
|---|---|---|---|---|---|
| 2.37-2.42 | 1.18-1.25 | 1.21-1.29 | 0.20-0.28 | 37.38-37.52 | Balance |

PTA Alloy #6 Matrix Hardness Rc 54-56

| Carbon | Boron | Silicon | Iron | Nickel | Tungsten |
|---|---|---|---|---|---|
| 2.34-2.44 | 1.15-1.23 | 1.20-1.30 | 0.22-0.29 | 37.44-37.62 | Balance |

A first pass of nickel-based matrix alloy comprised of about 37 to 48 wt % nickel-based matrix alloy described above had a second pass of iron-based matrix alloy having about 60 wt % crushed and sintered tungsten carbide particles deposited onto the first inner coat of nickel-based alloy at a temperature of about 315° C. The second outer coat had the following general percent composition.

Alloy #4 Matrix Hardness Rc 56 to 59

| Carbon | Boron | Silicon | Iron | Nickel |
|---|---|---|---|---|
| 0% | 3% | 3% | 48% | Balance |

This combination of softer inner layer of nickel-based matrix alloy containing carbides having a hardness in the range of Rc 31-36 and outer layer of harder iron-based matrix alloy containing carbides having a hardness in the range of Rc 56-59 was effective in extending the life of hard faced screens in shaker box applications for a three-fold reduction of down time and in rotary breaker applications for a two-fold reduction of down time compared to conventional screens.

We have found that the provision of shaped stud-like protrusions on the wearing surface of the breaker plates significantly enhances the rate of breaking down large oversized lumps of oil sands passing over inclined shaking tables or through rotary drums having an axis of rotation inclined at an angle of about 10° to the horizontal.

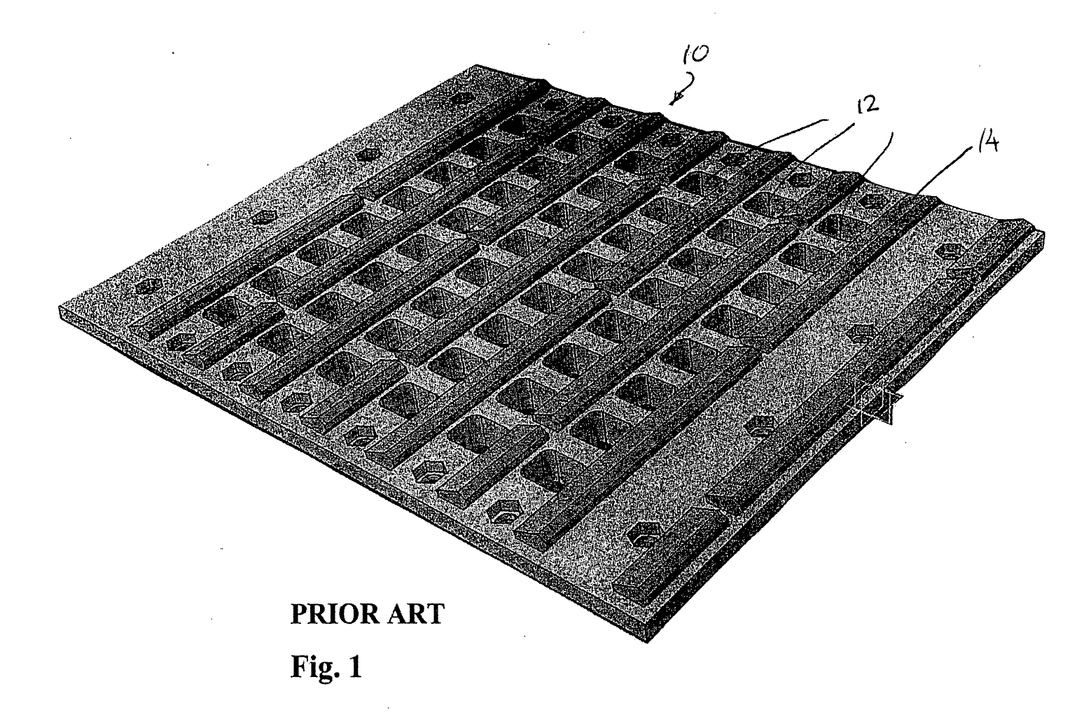

With reference first to FIG. 1 of the drawings, a prior art breaker plate 10 is shown made of carbon steel having transverse rows of openings 12 forming a sieve for the passage of undersize particles of oil sand therethrough. Transverse bars 14 of white cast iron typically are welded onto the substrate of carbon steel plate 10 between the transverse rows of openings 12 to assist in breaking down the lumps of oversize oil sands passing over. Not only is the process of breaking down the lumps not efficient, but also the bars are brittle due to the welding process required to attach the bars to the substrate and therefore subject to cracking by the impact thereon of heavy lumps of oil sands.

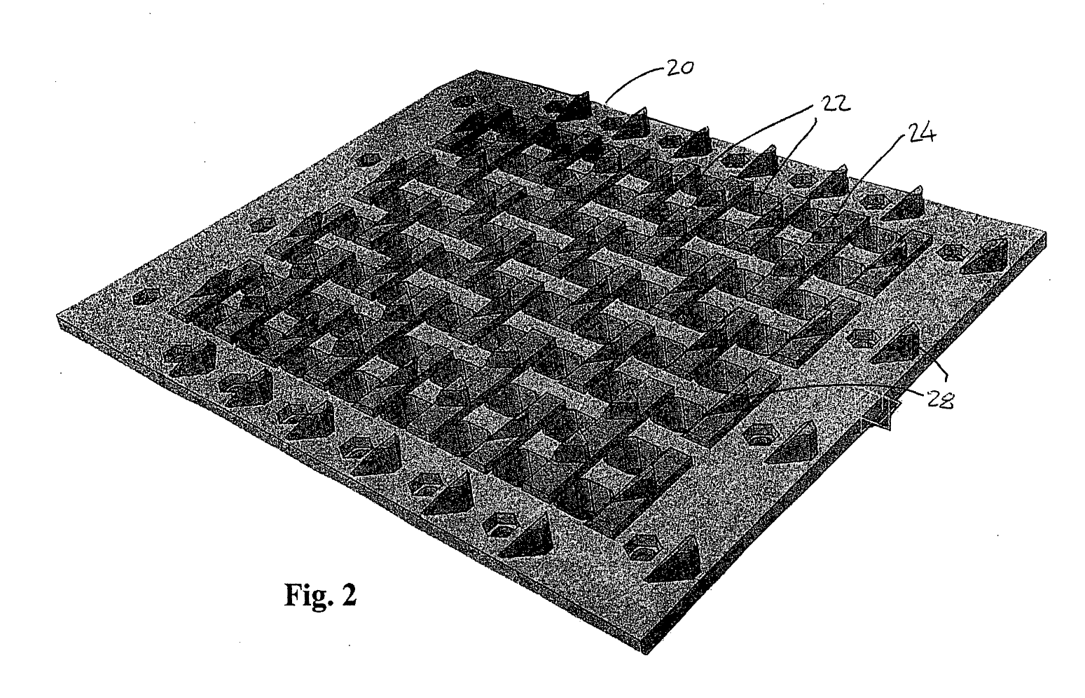

With reference now to FIG. 2 of the drawings, carbon steel plate 20 having transverse rows of holes 22 found therein has transverse rows of upstanding wedge-shaped protrusions or studs 24 attached to plate 20 between the transverse rows of holes 22 and comprising at least 10% of the area of the plate. Protrusions 24 are formed on or attached to plates 20 by welding. The apex or point 28 of the wedge shaped protrusions faces the oncoming travel of oversize lumps and the wedges are short and wide to effectively absorb the impact of oil sand lumps dropped thereon and to break down the lumps. This embodiment is particularly suited for use on shaker tables.

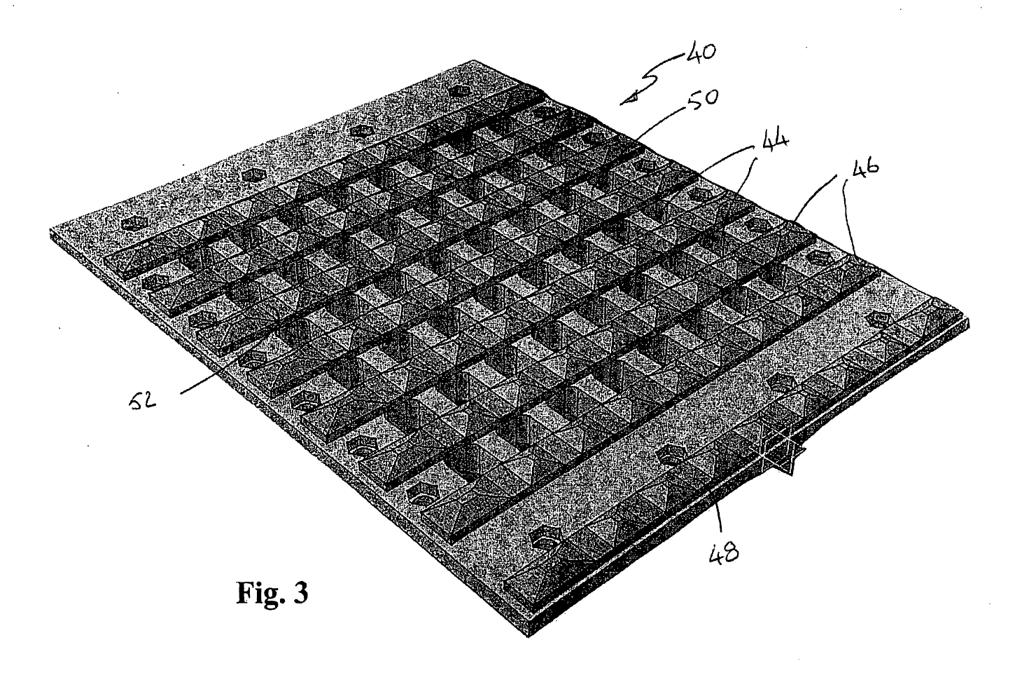

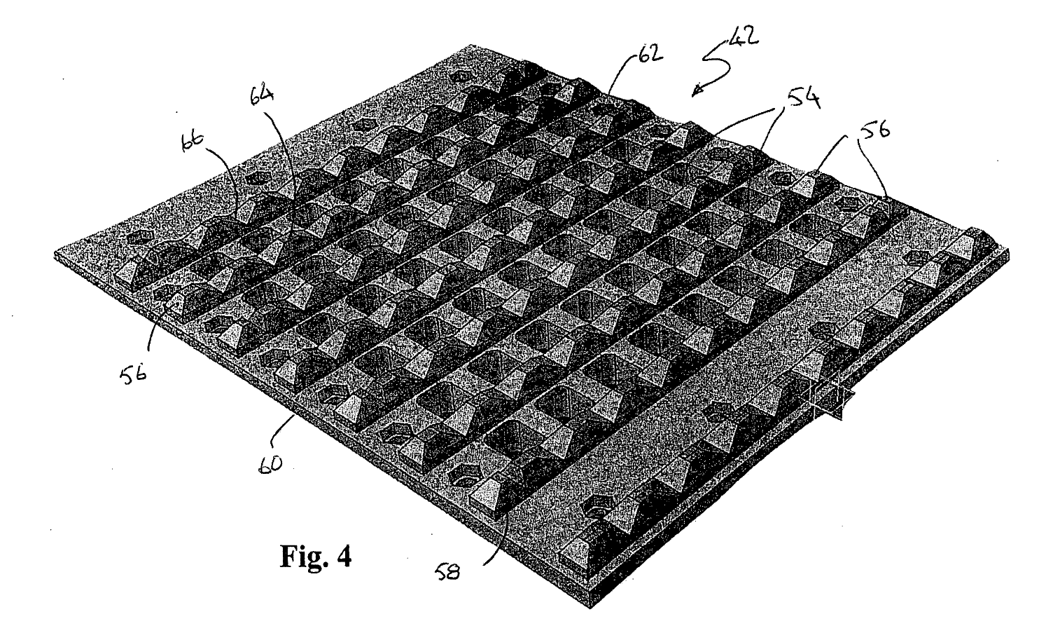

FIGS. 3 and 4 show breaker plates 40, 42 particularly suited for use in rotary breaker drums and have an arcuate shape to fit the peripheral contour of the drums. Typical drums employed in the oil sands are 7 feet or 16 feet in diameter having rectangular breaker plates 34×45 inches in size or 72 inches square respectively. With reference to FIG. 1 breaker plate 40 has transverse rows of openings 44 with transverse rows of pyramid protrusions 46 arranged between the rows of holes 44. Protrusions 46 are formed on an elongated steel strip 48 which is welded to the breaker plate 40 whereby the pyramid protrusions 46 preferably are aligned with the longitudinal plate metal 50 between holes 44 with spaces 52 between the protrusions 46 aligned with the holes to facilitate passage of undersized material through the holes. Each pyramid protrusion has a square base and preferably a flattened apex.

With reference to FIG. 4, breaker plate 42 has transverse rows of holes 54 with transverse rows of pyramid protrusions 56 arranged between the rows of holes 54. Pyramid protrusions 56 are formed on an elongated steel strip 58 and have an elongated rectangular bases extending along the steel strip whereby the sides of the pyramid protrusions abut each other. The rows of protrusions 56 extend from one side wall 60 to the opposite side wall 62 and are welded to the breaker plate whereby the apices 64 of one row of protrusions 56 alternate with the valley 66 of the adjacent rows such that one row of apices are aligned with holes 54 and the next row of apices are out of alignment with the holes 54.

The exposed surfaces of each pyramid or wedge protrusion preferably has a dual layer hard faced coating, as has been described above, or is formed of a wear and erosion resistant material.

The present invention provides a number of important advantages. Oversized lumps from crushed oil sands processed by primary roll crushers are effectively disintegrated and broken down in size suitable for wet screening with hot water for slurrying and pumping as a slurry or separation of bitumen from the sand. The breaker plates having the hard-faced shaped protrusions on wearing surfaces thereof or fabricated of wear and erosion resistant material covering at least 10% of the area of the plate surface provide point load impact zones to the lumps impacting thereon to quickly break down the oil sands to a sieve size that will pass through the plate holes, thereby minimizing impact loading and abrasive wear on the breaker plates and extending the working life of the breaker plate components.

It will be understood that other embodiments and examples of the invention will be readily apparent to a person skilled in the art, the scope and purview of the invention being identified in the appended claims.

1. A breaker plate comprising a plate having a pattern of holes formed in the plate extending across the plate on a surface thereof and with protrusions formed on or attached to the surface of the plate between the holes and covering at least 10% of the area of the plate, said protrusions consisting of wear and erosion resistant material or hard surfaced with a wear and erosion resistant material.

2. A breaker plate comprising a rectangular plate with spaced-apart sidewalls and endwalls and equispaced rows of holes finned in the plate extending across the plate on a surface thereof from one side to the other, rows of pyramid projections or wedge projections formed on the surface of the plate between the rows of holes and extending from one side of the plate to the other.

3. A breaker plate as claimed in claim 2, in which one or a plurality of the pyramid projections or wedge projections are formed on base strips and the base strips attached by welding onto the surface of the plate.

4. A breaker plate as claimed in claim 3, in which the pyramid projections or wedge projections are attached to the surface of the plate out of alignment with the holes.

5. A breaker plate as claimed in claim 3, in which rows of the pyramid projections are attached to the surface of the plate with alternate rows out of alignment with the holes.

6. A breaker plate as claimed in claim 2, in which the pyramid projections or wedge projections are made of a wear or erosion resistant material or are hard surfaced with a wear or erosion resistant material.

7. A breaker plate as claimed in claim 2, in which the pyramid projections or wedge projections are hard surfaced with a dual layer hard faced coating.
